(19) United States
(12) Patent Application Publication
(10) Pub. No.: US 2020/0138246 A1
(43) Pub. Date: May 7, 2020

(54) LOW POWER DEVICES HAVING INFRARED SENSORS FOR BOTH DETECTING PROXIMITY OF AN OBJECT AND FOR TRANSMITTING DATA

(71) Applicant: GOJO Industries, Inc., Akron, OH (US)

(72) Inventors: Jackson W. Wegelin, Stow, OH (US); Chip W. Curtis, La Moille, IL (US)

(21) Appl. No.: 16/674,077

(22) Filed: Nov. 5, 2019

Related U.S. Application Data
(60) Provisional application No. 62/755,692, filed on Nov. 5, 2018.

(51) Int. Cl. A47K 5/12; G01J 5/02; G06F 21/31

(52) U.S. Cl. CPC A47K 5/1217; A47K 5/1202; G06F 21/31; G01J 5/028; G01J 5/027

(57) ABSTRACT

Exemplary embodiments of low power devices having an infrared transmitter for detecting an object in a sensing area and for transmitting data signals are disclosed herein. An exemplary low power device may be a soap, sanitizing or lotion dispenser. The soap, sanitizer or lotion dispenser includes a housing, a processor, memory, an infrared transmitter, an infrared receiver, and an actuator. The dispenser further includes logic stored on the memory for causing the infrared transmitter to transmit a signal into a sensing area to detect an object and for causing the infrared transmitter to transmit a modulated infrared signal wherein the modulated infrared signal is a data signal.

### RELATED APPLICATIONS

The present invention claims the benefits of, and priority to, U.S. Provisional Applicant Ser. No. 62/755,692 titled LOW POWER DEVICES HAVING INFRARED SENSORS FOR BOTH DETECTING PROXIMITY OF AN OBJECT AND FOR TRANSMITTING DATA, which was filed on Nov. 5, 2018 and is hereby incorporated herein by reference in its entirety.

### TECHNICAL FIELD

The present invention relates generally to low power devices having infrared sensors and transmitters and more particularly to low power devices, such as, soap/sanitize dispensers and people counters that have infrared sensors that both detect objects within their proximity and transmit data.

### BACKGROUND OF THE INVENTION

Selected battery-operated devices, such as, for example, hands-free (or touch-free) soap, sanitizer or lotion dispensers, people counters and the like include an infrared (“IR”) sensor that senses an object, such as, for example, a user's hands or the presence of a person or piece of equipment as it enters or leaves a hospital room. There are times when it is useful to obtain information indicative of if, and/or when, a person washes or sanitizes their hands. One way to obtain such information is disclosed in Applicants patent application, U.S. Pat. No. 8,847,752, which is titled Hygiene Compliance Module. The hygiene compliance module is inserted into a dispenser and connects to the dispenser via a communications port. The hygiene compliance module receives a signal indicative of a dispenser dispense from the dispenser, and the hygiene compliance module transmits the signal to a data management system. The hygiene compliance modules are expensive and can only be installed in dispensers that have communications ports.

### SUMMARY

Exemplary embodiments of low power touch-free devices having an infrared transmitter for detecting an object in a sensing area and for transmitting data signals are disclosed herein. An exemplary low power touch-free device may be a soap, sanitizing or lotion dispenser. The soap, sanitizer or lotion dispenser may include a housing, a processor, memory, an infrared transmitter, an infrared receiver, and an actuator. The dispenser may further includes logic stored on the memory for causing the infrared transmitter to transmit a signal into a sensing area to detect an object and for causing the infrared transmitter to transmit a modulated infrared signal wherein the modulated infrared signal is a data signal.

Exemplary embodiments of monitoring systems are also disclosed herein. An exemplary monitoring system includes a touch-free device, such as, for example, a sanitizer dispenser. The sanitizer dispenser may include a housing, a processor, memory, an infrared transmitter, an infrared receiver, an actuator, logic for causing the infrared transmitter to transmit a signal into a sensing area to detect an object, and logic for causing the infrared transmitter to transmit a modulated infrared signal wherein the modulated infrared signal is a data signal. The system further may include a gateway. The gateway may include a processor, an infrared receiver; and long range wireless communication circuitry. The gateway infrared receiver is configured to receive the data signal transmitted by the sanitizer dispenser and the gateway is configured to transmit a gateway data signal via the long range wireless communication circuitry, wherein the gateway data is indicative of a dispense event and a dispenser identification.

Another exemplary touch-free device, which may be, for example, a soap, sanitizing or lotion dispenser may include a housing, a plurality of batteries, a processor, memory, an infrared transmitter configured for transmitting a unmodulated signal for detecting an object in a sensing area and for transmitting a modulated signal that contains data and an actuator. The dispenser may further includes logic stored on the memory for causing the infrared transmitter to transmit a signal into a sensing area to detect an object, logic stored on the memory for causing the actuation to dispense a dose of product, and logic stored on the memory for causing the infrared transmitter to transmit a modulated infrared signal wherein the modulated infrared signal is a data signal and the data signal comprises data indicative of the occurrence of a dispense event.

### BRIEF DESCRIPTION OF THE DRAWINGS

These and other features and advantages of the present invention will become better understood with regard to the following description and accompanying drawings in which:

FIG. 1 is a prospective view of a touch-free device having an IR object sensor and data transmitter;

FIG. 2 is a front view of selected internal components of the touch-free device of FIG. 1;

FIG. 3 is a prospective view of an exemplary embodiment of a counter-mount touch-free dispenser having an IR object sensor and data transmitter;

FIG. 4 is a schematic view of an exemplary embodiment of selected low power touch-free devices having infrared sensors for both detecting proximity of an object and for transmitting data;

FIG. 5 is simplified schematic block diagram an exemplary embodiment of a low power devices having infrared sensors for both detecting proximity of an object and for transmitting data;

FIGS. 6-8 are exemplary methodologies for detecting and object and transmitting data with low power devices having infrared sensors for both detecting proximity of an object and for transmitting data; and

FIG. 9 is another exemplary touch-free device having an IR object sensor and data transmitter.

### DETAILED DESCRIPTION

The following includes definitions of exemplary terms used throughout the disclosure. Both singular and plural forms of all terms fall within each meaning. Except where noted otherwise, capitalized and non-capitalized forms of all terms fall within each meaning:

“Circuit communication” as used herein indicates a communicative relationship between devices. Direct electrical, electromagnetic and optical connections and indirect electrical, electromagnetic and optical connections are examples of circuit communication. Two devices are in circuit communication if a signal from one is received by the other, regardless of whether the signal is modified by some other device. For example, two devices separated by one or more of the following—amplifiers, filters, transformers, optoisolators, digital or analog buffers, analog integrators, other electronic circuitry, fiber optic transceivers or satellites—are in circuit communication if a signal from one is communicated to the other, even though the signal is modified by the intermediate device(s). As another example, an electromagnetic sensor is in circuit communication with a signal if it receives electromagnetic radiation from the signal. As a final example, two devices not directly connected to each other, but both capable of interfacing with a third device, such as, for example, a CPU, are in circuit communication.

Also, as used herein, voltages and values representing digitized voltages are considered to be equivalent for the purposes of this application, and thus the term “voltage” as used herein refers to either a signal, or a value in a processor representing a signal, or a value in a processor determined from a value representing a signal.

“Signal”, as used herein includes, but is not limited to one or more electrical signals, analog or digital signals, one or more computer instructions, a bit or bit stream, or the like.

“Logic,” synonymous with “circuit” as used herein includes, but is not limited to hardware, firmware, software and/or combinations of each to perform a function(s) or an action(s). For example, based on a desired application or needs, logic may include a software controlled microprocessor or microcontroller, discrete logic, such as an application specific integrated circuit (ASIC) or other programmed logic device. Logic may also be fully embodied as software. The circuits identified and described herein may have many different configurations to perform the desired functions.

The values identified in the detailed description are exemplary and they are determined as needed for a particular dispenser and/or refill design. Accordingly, the inventive concepts disclosed and claimed herein are not limited to the particular values or ranges of values used to describe the embodiments disclosed herein.

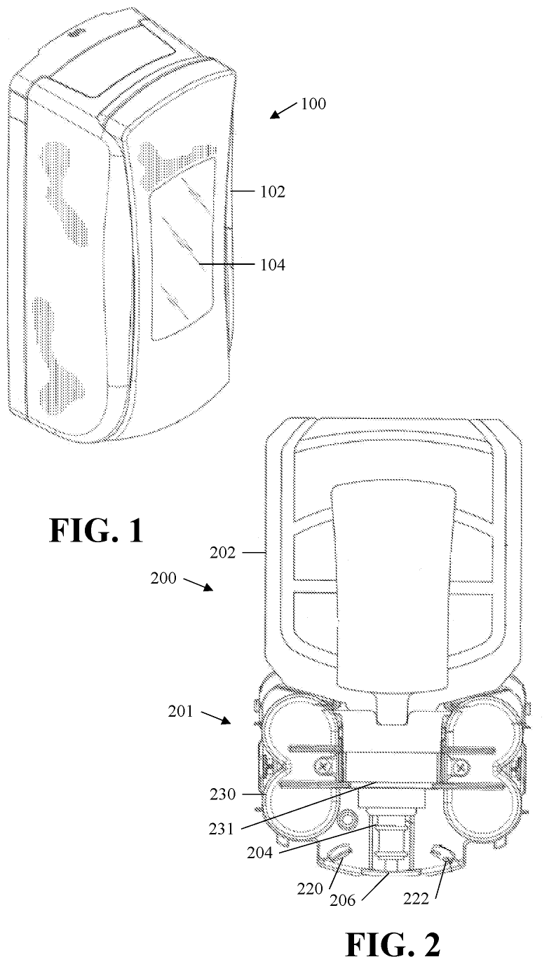

FIG. 1 is a prospective view of a low power device in the form of a dispenser 100 having and infrared sensor for both detecting proximity of an object and for transmitting data. Dispenser 100 is a dispenser for dispensing hand sanitizer, soap or lotion. Dispenser 100 includes a housing 102 that has a window 104. Located within dispenser 100 is a refill unit 200 (FIG. 2) and a pump house 201. Refill unit 200 includes a container 202 and a pump 204 that has an outlet 206. Pump 204 is a piston foam pump, however, pump 204 may be a liquid pump. Further pump 204 may be any type of pump, such as, for example, a dome pump, a diaphragm pump, a peristaltic pump, aa sequentially activated diaphragm foam pump or the like.

Pump house 201 includes power source 230, which may be, for example, a plurality of batteries. In addition, pump house 201 includes an actuator 231 for causing foam pump 204 to dispense product. Pump house 201 includes an infrared (“IR”) transmitter 220 and an IR receiver 222. Pump house 201 includes a processor (not shown), memory (not shown), power conditioning circuitry (not shown). IR transmitter 220 is configured to periodically emit a signal that is reflected back to IR receiver 222 in the event that an object, such as, for example, a hand, is present in the sensing range. Upon detecting that an object is present, actuator 231 operates foam pump 204 to dispense a dose of foam product.

In some embodiments, IR transmitter 220 emits a data signal upon actuation of the dispenser 100. In some embodiments, the data signal is indicative of the dispense event. In some embodiments, the data signal is indicative of a fluid level in the refill unit 200. In some embodiments, the data signal is indicative of a fault with the dispenser 100. In some embodiments, the data signal is indicative of a pump 204 error, such as, for example, a clogged pump, a locked pump, and the like. In some embodiments, the data signal is indicative of a dispenser identifier, such as, for example, a serial number or a dispenser location. In some embodiments, the data signal is indicative of a user identification, such as, for example, a badge number assigned to the user. In some embodiments, the data signal is a combination of two or more of the foregoing.

The data signal may be received by, for example, a gateway (not shown). In some embodiments, the gateway includes and IR receiver. The data signal may be received by, for example, a gateway (not shown). In some embodiments, the gateway includes an IR receiver and an IR transmitter. In some embodiments, the gateway includes additional communications circuitry for communicating the data signal to a remote location. In some embodiments, the additional communications circuitry connects via a wire, such as, for example, and ethernet cable, to the remote location. In some embodiments, the additional communications circuitry connects wirelessly, such as, for example, through WiFi, to the remote location. In some embodiments, the remote location is a computer terminal containing software for reporting information relating to the data signal.

In some embodiments, one or more badges (not shown) are included in the system. In some embodiments, after an object is detected, IR transmitter 220 stops emitting object detection signals and IR receiver 222 listens for a data signals from a badge (not shown) worn by the user that caused the dispenser to dispense. The data signal from the badge may be indicative of a unique identifier, such as, for example, an identification number, associated with the badge. In some embodiments, the badge unique identifier may be associated with a user ID. In some embodiment, the dispenser 100 emits a conformation signal to the badge that the dispenser 100 received the badge data signal. In some embodiments, the data signal transmitted from the IR transmitter 220 includes the unique identifier associated with the badge.

After dispensing a dose of fluid, IR transmitter 220 broad casts a data signal indicative at least in part of dispensing a dose of fluid. In some embodiments, the data signal includes one or more of the following: a dispenser identifier, a time of dispense, a badge identifier, a data signal identifier, a level indication, a dispenser fault indication, a refill fault indication or the like. In some embodiments the dispenser 100 waits or delays for a period of time after dispensing fluid so that the user has time to leave and does not block the data signal. In some embodiments, a gateway (not shown) or remote terminal acknowledges receipt of the signal and the acknowledgement is received by receiver 222. In some embodiments, no acknowledgment is transmitted by the gateway or remote terminal. In some embodiments, dispenser 100 transmits the data signal multiple times to ensure that at least one of the signals is received by the gateway. The gateway, or computer at the remote location may determine if the same data signal has been received multiple times and remove duplicates. In some embodiments, duplicate signals are determined as a function of the time of dispense. In some embodiments, duplicate signals are determined as a function of the data signal identifier.

Although FIGS. 1 and 2 show and describe a dispenser for dispensing fluid onto a user's hands, the inventive concepts disclosed herein may be used on any touch-free device that utilizes an IR device to detect the presence of a person, such as, for example, paper towel dispensers, toilet paper dispensers, faucets, flush valves and the like.

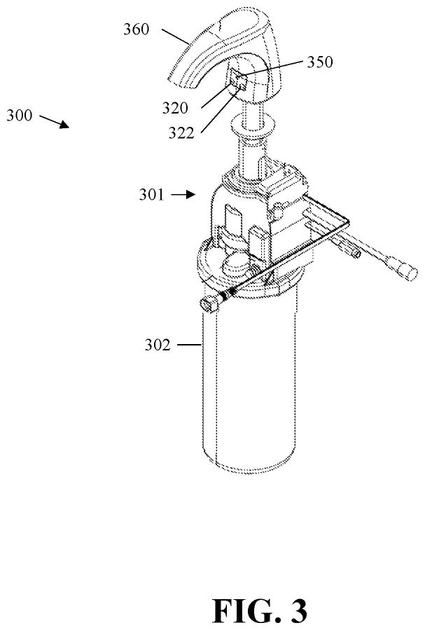

FIG. 3 is a prospective view of a counter-mount dispenser 300. Counter-mount dispenser 300 includes a pump house 301 that performs similar functions to those described above with respect to pump house 201. Pump house 301 is configured to be mounted below a counter. In addition, counter-mount dispenser 300 includes a container 302 that is configured to be filled with a product, such as, for example, soap, sanitizer, or lotion and is configured to be mounted under a counter. Counter-mount dispenser 300 includes a spout 360. Located at the base spout 360 is an IR transmitter 320 and an IR receiver 322. IR transmitter 320 and IR receiver 322 may be configured as described above with respect to IR transmitter 220 and IR receiver 222. Accordingly, IR transmitter 320 may be used to detect the presence of an object in a detection zone and to broadcast one or more data signals to a gateway or other IR receiving device as described above.

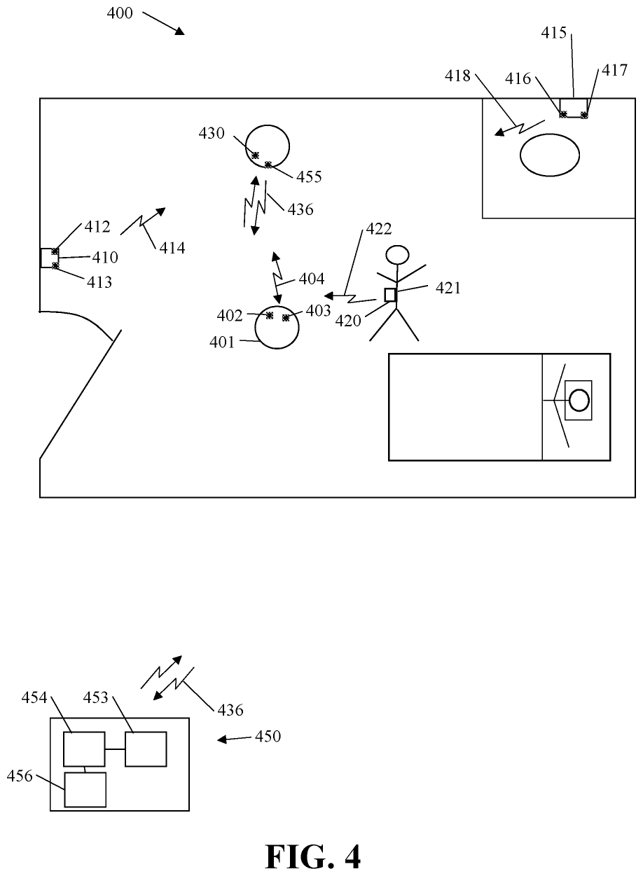

FIG. 4 is a schematic view of an exemplary embodiment of system 400 having a plurality of exemplary low power devices that include infrared transmitters/receivers for both detecting proximity of an object and for transmitting data. The exemplary low power devices having infrared sensors for both detecting proximity of an object and for transmitting data of exemplary system 400 include: a people counter 401; a sanitizer dispenser 410 and a soap dispenser 415.

People counter 401 include an IR transmitter 402, and an IR receiver 403; sanitizer dispenser 410 includes an IR transmitter 412 and an IR receiver 413 and soap dispenser 415 includes an IR transmitter 416 and an IR receiver 417. The exemplary system 400 includes gateway 430 that is in circuit communications with the plurality of low power devices and a remote computer or master station 450. Gateway 430 includes an IR receiver 432 that may receive data signals from the plurality of low power devices having infrared transmitters/receivers and additional communications circuitry 435 for data transmission from the gateway 430 to the master station 450. The additional communication circuitry may be, for example, wireless communication circuitry, such as, for example, WIFI communications circuitry, or may be hard wired communications circuitry connected by, for example, an either net cable. In this exemplary embodiment, additional communications circuitry 435 is wireless communications circuitry and transmits and receives wireless signals 435. Master station 450 includes a processor 454 in circuit communications with communications circuitry 453 and a display 456.

In an exemplary embodiment, when a user 421 enters the room, the user's badge 420 emits an IR signal 422 that is received by IR receiver 403 in people counter 401. The signal is indicative of a unique identifier associated with user 421. IR transmitter 402 of People counter 401 transmits the signal to IR receiver 432 of gateway 430. If user 421 moves over to soap dispenser 416 and places her hand under soap dispenser 415, an IR signal emitted from IR transmitter 416 bounces off of the user's hand and is received by IR receiver 417 providing an indication to dispenser 415 that an object is in place and the dispenser 415 dispenses soap onto the user's hand. In some embodiments, upon actuation, IR transmitter 416 stops transmitting and IR receiver 417 listens for a signal 422 from the badge 420 indicating who has obtained a dose of soap. The IR transmitter 416 transmits an IR signal 418 to the IR receiver 432 of gateway 430. IR signal 418 may contain any of the information identified herein as being transmitted by the dispenser and people counters.

Similarly, if user 421 moves over to sanitizer dispenser 410 and places her hand under sanitizer dispenser 410, an IR signal emitted from IR transmitter 412 bounces off of the user's hand and is received by IR receiver 413 providing an indication to dispenser 410 that an object is in place and the dispenser 410 dispenses sanitizer onto the user's hand. In some embodiments, upon actuation, IR transmitter 412 stops transmitting and IR receiver 413 listens for a signal 422 from the badge 420 indicating who has obtained a dose of sanitizer. The IR transmitter 412 transmits an IR signal 414 to the IR receiver 432 of gateway 430. IR signal 414 may contain any of the information identified herein as being transmitted by the dispenser and people counters.

Gateway 430 transmits these signals vie communications circuitry 435 as signals 436 to master station 450 where the information is processed and may be displayed on display 146.

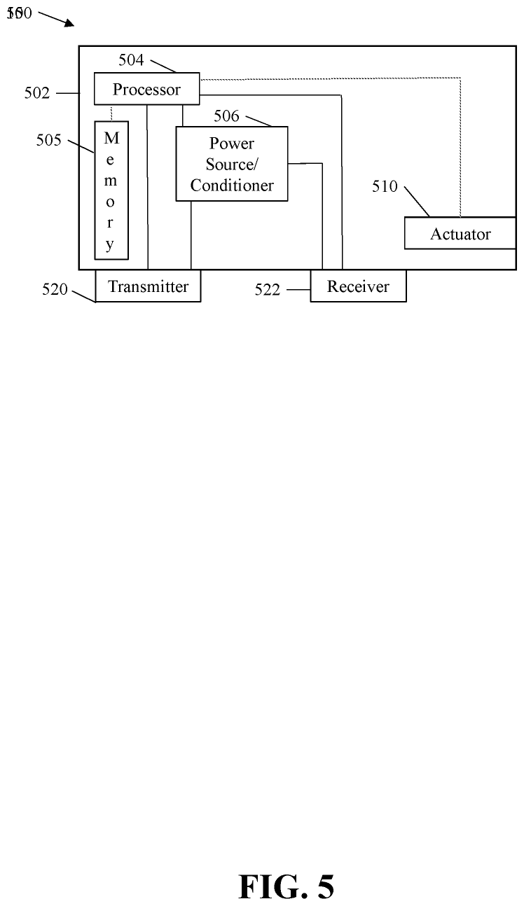

FIG. 5 is a high-level schematic block diagram illustrating an exemplary embodiment of a low power touch-free devices having infrared sensors for both detecting proximity of an object and for transmitting data. In this exemplary embodiment the low power device is a dispenser 500, but may be any touch-free device that senses a user and initiates an actuation. Dispenser 500 includes a housing 502, a processor 504 in circuit communication with memory 505, a IR signal transmitter 520, a IR signal receiver 522, power source 506, conditioning circuitry 506, and an actuator 510.

Processor 504 may be any type of processor, such as, for example, a microprocessor or microcontroller, discrete logic, such as an application specific integrated circuit (ASIC), other programmed logic device or the like. Depending on the need, memory 505 may be any type of memory, such as, for example, Random Access Memory (RAM); Read Only Memory (ROM); programmable read-only memory (PROM), electrically programmable read-only memory (EPROM), electrically erasable programmable read-only memory (EEPROM), flash, magnetic disk or tape, optically readable mediums including CD-ROM and DVD-ROM, or the like, or combinations of different types of memory. In some embodiments, the memory 505 is separate from the processor 504, and in some embodiments, the memory 505 resides on or within processor 504.

Power source 506 is in circuit communications with the associated circuitry for providing power as needed. In some embodiments, a voltage regulator (not shown) is used to condition the power supplied by power source 506. Power source 506 may be any type of power source, such as, for example, one or more batteries, line voltage, solar cells, or the like. Typically, power source 506 includes one or more batteries. In some embodiments, a power source is not needed and the circuitry is powered through existing power sources in the dispensers/receptacles.

Transmitter 510 is an IR transmitter and receiver 522 is IR transmitter. Located in memory 505 includes logic for causing the IR transmitter and to alternately transmit a signal that may be received by IR receiver 522 to identify an object located within the sensing range of the IR receiver 522 and to transmit a data signal that may be received by a remote device, such as, for example, a gateway (not shown). In some embodiments, when IR transmitter 520 is transmitting a data signal, IR receiver 522 is deactivated. In some embodiments, when IR transmitter 520 is transmitting a data signal, the processor 504 is configured to ignore signals received from IR receiver 522.

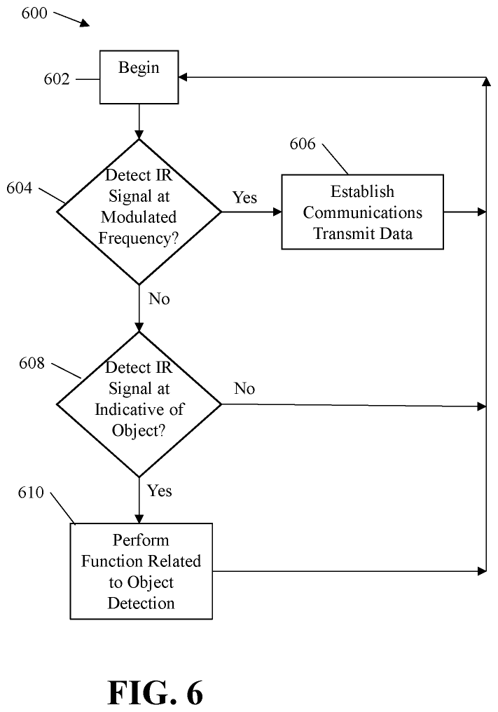

FIGS. 6-8 are exemplary methodologies and logic diagrams for detecting and object and transmitting data with low power devices having infrared sensors for both detecting proximity of an object and for transmitting data. The exemplary methodologies may include more steps or blocks or fewer steps or blocks. In addition, in some embodiments, the steps or blocks may be arranged in different orders. Further, steps or blocks in one methodology may be incorporated into other methodologies.

FIG. 6 is an exemplary methodology of using an IR transmitter to communicate data and to detect an object. The exemplary methodology or logic begins at block 602. At block 604, a determination is made as to whether the IR signal is being transmitted at a modulated frequency. If it is, communications are established with a receiver at block 606 and the data is transmitted by decoding the modulated IR signal and the methodology loops to block 602. In some embodiments, a communications link is not established and the IR transmitter merely transmits the modulated IR data signal. In some embodiment, the IR transmitter transmits the modulated IR data signal multiple times to improve accuracy if the first transmission is not received by the desired IR receiver.

If the IR signal is not being transmitted at a modulated frequency, the methodology flows to block 608. At block 608, a determination is made as to whether an object is within the object sensing range. If it is not, the methodology loops to block 602. If it is, the methodology flows to block 610 and the device performs one or more functions related to the detection of the object, such as, for example, causing a dispenser to dispense a product or transmitting data relating to the detected object.

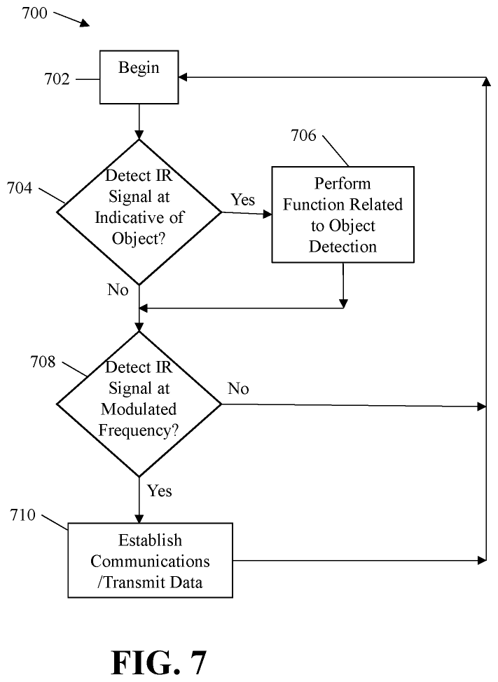

FIG. 7 is an exemplary methodology of using an IR transmitter to communicate data and to detect an object. The exemplary methodology or logic begins at block 702. At block 704, a determination is made as to whether an object is within the object sensing range. In this mode, the IR transmitter is configured in the object detection mode and the frequency of the IR signal is set at a frequency that is an unmodulated frequency. The term “unmodulated frequency” does not mean that the frequency does not change, only that it is not a modulated signal that may be decoded to obtain data. If no object is detected, the methodology flows to block 708. If an object is detected, the methodology flows to block 706 and the device performs one or more functions related to the detection of the object, such as, for example, causing a dispenser to dispense a product or transmitting data relating to the detected object and the methodology flows to block 708. At block 708, a determination is made as to whether the IR signal is being transmitted at a modulated frequency. If it is, communications are established with a receiver at block 710 and the data is transmitted by decoding the modulated IR signal and the methodology loops to block 702. If the signal is not at a modulated frequency, the methodology flows to block 702.

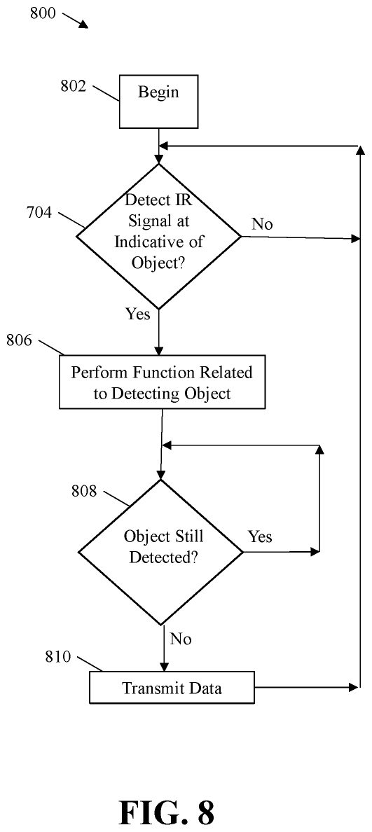

FIG. 8 is an exemplary methodology of using an IR transmitter to communicate data and to detect an object. The exemplary methodology or logic begins at block 802. At block 804, a determination is made as to whether an object is within the object sensing range. In this mode, the IR transmitter is configured in the object detection mode and the frequency of the IR signal is set at a frequency that is an unmodulated frequency. The term “unmodulated frequency” does not mean that the frequency does not change, only that it is not a modulated signal that may be decoded to obtain data. If no object is detected, the methodology flows to block 802. If an object is detected, the methodology flows to block 806 and the device performs one or more functions related to the detection of the object, such as, for example, causing a dispenser to dispense a product or transmitting data relating to the detected object and the methodology flows to block 808. At block 808, a determination is made as to whether an object is still being detected. If it is, the methodology loops back to block 808 and determines whether the object is still present. If the object is no longer present, data is transmitted at block 810 by a modulated IR signal and broadcast to a IR receiver located nearby and the methodology flows to block 802.

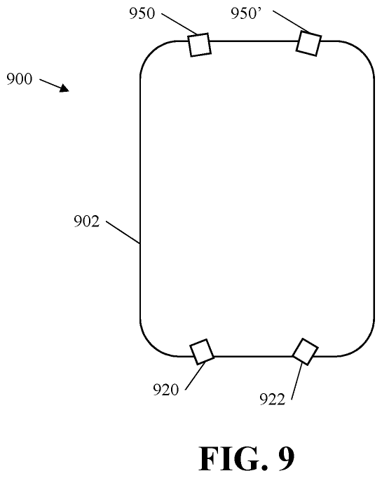

FIG. 9 is a block diagram of another touch-free device 900 having an IR object sensor and data transmitter. As with the above described embodiments, the touch-free device may be a fluid dispenser, a paper towel dispensers, toilet paper dispensers, faucets, flush valves and the like. In this exemplary embodiment, touch-free device 900 includes a power source (not shown), which may be, for example, a plurality of batteries. In addition, touch-free device 900 includes an actuator (not shown), for causing touch-free device 900 to dispense product or otherwise operate. Touch-free device 900 includes an infrared (“IR”) transmitter 920 and an IR receiver 922. Touch-free device 900 includes a processor (not shown), memory (not shown), power conditioning circuitry (not shown). IR transmitter 920 is configured to periodically emit a signal that is reflected back to IR receiver 922 in the event that an object, such as, for example, a hand, is present in the sensing range. Upon detecting that an object is present, the actuator causes the touch-free device 900 to dispense a product or otherwise operate.

In some embodiments, IR transmitter 920 emits a data signal upon actuation of the touch-free device 900. In some embodiments, the data signal is indicative of the dispense event or other operation. In some embodiments, the data signal is indicative of a product level, length of actuation, time of operation. In some embodiments, the data signal is indicative of a fault with the touch-free device 900. In some embodiments, the data signal is indicative of a dispense error, such as, for example, a clogged pump, a locked pump, a stalled actuator, too long of an actuation, failure of the actuator to return to its off state, and the like. In some embodiments, the data signal is indicative of a touch-free device identifier, such as, for example, a serial number or a touch-free device location. In some embodiments, the data signal is indicative of a user identification, such as, for example, a badge number assigned to the user. In some embodiments, the data signal is a combination of two or more of the foregoing.

The data signal may be received by, for example, a gateway (not shown). In some embodiments, the gateway includes and IR receiver. The data signal may be received by, for example, a gateway (not shown). In some embodiments, the gateway includes an IR receiver and an IR transmitter. In some embodiments, the gateway includes additional communications circuitry for communicating the data signal to a remote location. In some embodiments, the additional communications circuitry connects via a wire, such as, for example, and ethernet cable, to the remote location. In some embodiments, the additional communications circuitry connects wirelessly, such as, for example, through WiFi, to the remote location. In some embodiments, the remote location is a computer terminal containing software for reporting information relating to the data signal.

In this exemplary embodiment, touch-free device 900 may include one or more additional IR transmitters 950, 950′. The additional IR transmitters 950, 950′ may be located at different locations and/or at different angles then IR transmitter 920. IR transmitters 950, 950′ broadcast the same communication data that is being broadcast by IR transmitter 920. The use of additional IR transmitters 950, 950′ may allow a more direct line of sight to the IR receive that is receiving the data from the IR transmitters.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. It is not the intention of the applicant to restrict or in any way limit the scope of the appended claims to such detail. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order in which the steps are presented to be construed as required or necessary unless expressly so stated.

I/We claim:

1. A dispensing device comprising:
a housing;
a processor;
memory;
an infrared transmitter;
logic stored on the memory for causing the infrared transmitter to transmit a first signal into a sensing area to detect an object;
an actuator for causing the dispenser to dispense a dose of fluid upon the detection of the object;
logic stored on the memory for causing the infrared transmitter to transmit a second signal,
wherein the second signal is a modulated infrared signal; and
wherein the modulated infrared signal is a data signal; and
wherein the second signal includes data indicative of the dispenser dispensing a dose of fluid.

2. The dispensing device of claim 1 further comprising logic stored on the memory for causing the actuator to dispense a product and wherein the data signal is indicative of a dispense event.

3. The dispensing device of claim 1 wherein the data signal is indicative of a dispenser identification.

4. The dispensing device of claim 1 further comprising logic stored on the memory for receiving a unique identifier that correlates to a person's identity.

5. The dispensing device of claim 1 further comprising logic stored on the memory for waiting until an object is no longer present in the sensing area before transmitting the data signal.

6. The dispensing device of claim 1 further comprising establishing a communications link using a modulated infrared signal prior to transmitting the data signal.

7. The so dispensing device of claim 1 wherein the data signal comprises time of dispense data.

8. The so dispensing device of claim 1 wherein the touch-free device is soap, sanitizer or lotion dispenser

9. A soap, sanitizer or lotion dispenser comprising:
a housing;
a reservoir for holding soap, sanitizer or lotion;
a pump in fluid communication with the reservoir;
an actuator for actuating the pump to dispense a dose of fluid;
a plurality of batteries;
a processor;
memory;
an infrared transmitter located at least partially outside of the housing;
wherein the infrared transmitter is configured for transmitting a first signal and a second signal,
wherein the first signal is a signal for detecting an object in a sensing area;
wherein the second signal is a modulated signal;
wherein the first signal and the second signal are different from one another;
logic stored on the memory for causing the infrared transmitter to transmit the first signal into a sensing area to detect an object;
logic stored on the memory for causing the actuator to dispense a dose of product; and
logic stored on the memory for causing the infrared transmitter to transmit the second signal which is a data signal and the data signal comprises data indicative of the occurrence of a dispense of fluid.

10. The soap, sanitizer or lotion dispenser of claim 9 wherein the data signal is indicative of a dispenser identification.

11. The soap, sanitizer or lotion dispenser of claim 9 further comprising logic stored on the memory for receiving a unique identifier that correlates to a person's identity.

12. The soap, sanitizer or lotion dispenser of claim 9 further comprising logic stored on the memory for waiting until an object is no longer present in the sensing area before transmitting the data signal.

13. The soap, sanitizer or lotion dispenser of claim 9 further comprising establishing a communications link using a modulated infrared signal prior to transmitting the data signal.

14. The soap, sanitizer or lotion dispenser of claim 9 wherein the data signal comprises time of dispense data.

15. A dispensing device comprising:
a housing;
a plurality of batteries;
a processor;
memory;
an infrared transmitter configured for transmitting two different types of infrared signals;
a receiver for receiving one of the two different types of signals;
logic stored on the memory for causing the infrared transmitter to transmit a first signal into a sensing area to detect an object;
wherein the first signal reflects off of the object when the object is positioned in the sensing area and the reflected signal is detected by the receiver;
logic stored on the memory for causing the infrared transmitter to transmit a second signal that is a modulated infrared signal wherein the modulated infrared signal is a data signal and the data signal comprises data indicative of the occurrence of an actuation of the dispensing device.

16. The dispensing device of claim 15 wherein the data signal is indicative of a dispensing device identification.

17. The dispensing device of claim 15 further comprising logic stored on the memory for receiving a unique identifier that correlates to a person's identity.

18. The dispensing device of claim 15 further comprising logic stored on the memory for waiting until an object is no longer present in the sensing area before transmitting the data signal.

19. The dispensing device of claim 15 further comprising establishing a communications link using a modulated infrared signal prior to transmitting the data signal.

20. The dispensing device of claim 15 wherein the data signal comprises a time of actuation data.
